(19) United States
(12) Patent Application Publication
(10) Pub. No.: US 2010/0153366 A1
(43) Pub. Date: Jun. 17, 2010

(54) ASSIGNING AN INDEXING WEIGHT TO A SEARCH TERM

(75) Inventor: Chen Liu, Woodridge, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/334,842

(22) Filed: Dec. 15, 2008

(51) Int. Cl. G06F 17/30

(52) U.S. Cl. 707/722; 707/E17.014; 707/E17.017

(57) ABSTRACT

Disclosed is an indexing weight assigned to a potential search term in a document, the indexing weight is based on both textual and acoustic aspects of the term. In one embodiment, a traditional text-based weight is assigned to a potential search term. This weight can be TF-IDF (“term frequency-inverse document frequency”), TF-DV (“term frequency discrimination value”), or any other text-based weight. Then, a pronunciation prominence weight is calculated for the same term. The text-based weight and the pronunciation prominence weight are mathematically combined into the final indexing weight for that term. When a speech-based search string is entered, the combined indexing weight is used to determine the importance of each search term in each document. Several possibilities for calculating the pronunciation prominence are contemplated. In some embodiments, for pairs of terms in a document, an inter-term pronunciation distance is calculated based on inter-phoneme distances.

### FIELD OF THE INVENTION

The present invention is related generally to computer-mediated search tools and, more particularly, to assigning indexing weights to search terms in documents.

### BACKGROUND OF THE INVENTION

In a typical search scenario, a user types in a search string. The string is submitted to a search engine for analysis. During the analysis, many, but not all, of the words in the string become “search terms.” (Words such as “a” and “the” do not become search terms and are generally ignored.) The search engine then finds appropriate documents that contain the search terms and presents a list of those appropriate documents as “hits” for review by the user.

Given a search term, finding appropriate documents that contain that search term is a complex and sophisticated process. Rather than simply pull all of the documents that contain the search term, an intelligent search engine first preprocesses all of the documents in its collection. For each document, the search engine prepares a list of possible search terms that are contained in that document and that are important in that document. There are many known measures of a term's importance (called its “indexing weight”) in a document. One common measure is “term frequency-inverse document frequency” (“TF-IDF”). To simplify, this indexing weight is proportional to the number of times that a term appears in a document and is inversely proportional to the number of documents in the collection that contain the term. For example, the word “this” may show up many times in a document. However, “this” also shows up in almost every document in the collection, and thus its TF-IDF is very low. On the other hand, because the collection probably has only a few documents that contain the word “whale,” a document in which the word “whale” shows up repeatedly probably has something to say about whales, so, for that document, “whale” has a high TF-IDF.

Thus, an intelligent search engine does not simply list all of the documents that contain the user's search terms, but it lists only those documents in which the search terms have relatively high TF-IDFs (or whatever measure of term importance the search engine is using). In this manner, the intelligent search engine puts near the top of the returned list of documents those documents most likely to satisfy the user's needs.

However, this scenario does not work so well when the user is speaking the search string rather than typing it in. In a typical scenario, the user has a small personal communication device (such as a cellular telephone or a personal digital assistant) that does not have room for a full keyboard. Instead, it has a restricted keyboard that may have many tiny keys too small for touch typing, or it may have a few keys, each of which represents several letters and symbols. The user finds that the restricted keyboard is unsuitable for entering a sophisticated search query, so the user turns to speech-based searching.

Here, the user speaks a search query. A speech-to-text engine converts the spoken query to text. The resulting textual query is then processed as above by a standard text-based search engine.

While this process works for the most part, speech-based searching presents new issues. Specifically, the known art assigns indexing weights to terms in a document based purely on textual aspects of the document.

### BRIEF SUMMARY

The above considerations, and others, are addressed by the present invention, which can be understood by referring to the specification, drawings, and claims. According to aspects of the present invention, a potential search term in a document is assigned an indexing weight that is based on both textual and acoustic aspects of the term.

In one embodiment, a traditional text-based weight is assigned to a potential search term. This weight can be TF-IDF, TF-DV (“term frequency-discrimination value”), or any other text-based weight. Then, a pronunciation prominence weight is calculated for the same term. The text-based weight and the pronunciation prominence weight are mathematically combined into the final indexing weight for that term. When a speech-based search string is entered, the combined indexing weight is used to determine the importance of each search term in each document.

Just as there are many known possibilities for calculating the text-based indexing weight, several possibilities for calculating the pronunciation prominence are contemplated. In some embodiments, for pairs of terms in a document, an inter-term pronunciation distance is calculated based on inter-phoneme distances. Data-driven and phonetic-based techniques can be used in calculating the inter-phoneme distance. Details of this procedure and other possibilities are described below.

### BRIEF DESCRIPTION OF THE SEVERAL VIEWS OF THE DRAWINGS

While the appended claims set forth the features of the present invention with particularity, the invention, together with its objects and advantages, may be best understood from the following detailed description taken in conjunction with the accompanying drawings of which:

FIG. 1 is an overview of a representational environment in which the present invention may be practiced;

FIG. 2 is a flowchart of an exemplary method for assigning an indexing weight to a search term;

FIG. 3 is a dataflow diagram showing how indexing weights can be calculated; and

FIGS. 4a and 4b are tables of experimental results comparing the performance of indexing weights calculated according to the present invention with the performance of indexing weights of previous techniques.

### DETAILED DESCRIPTION

Turning to the drawings, wherein like reference numerals refer to like elements, the invention is illustrated as being implemented in a suitable environment. The following description is based on embodiments of the invention and should not be taken as limiting the invention with regard to alternative embodiments that are not explicitly described herein.

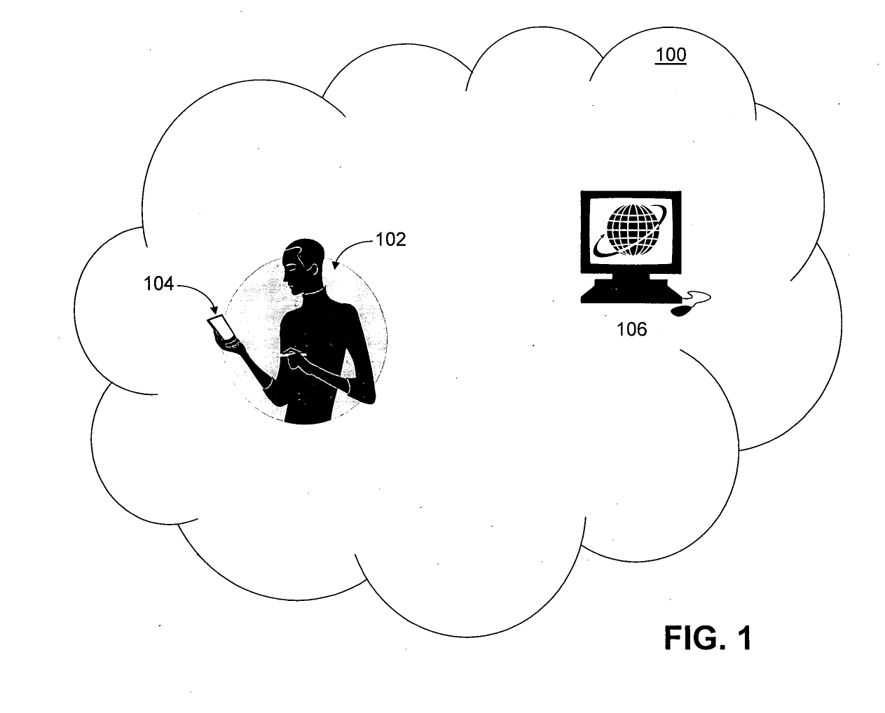

In FIG. 1, a user 102 is interested in launching a search. For whatever reason, the user 102 chooses to speak his search query into his personal communication device 104 rather than typing it in. The speech input of the user 102 is processed (either locally on the device 104 or on a remote search server 106) into a textual query. The textual query is submitted to a search engine (again, either locally or remotely). Results of the search are presented to the user 102 on a display screen of the device 104. The communications network 100 enables the device 104 to access the remote search server 106, if appropriate, and to retrieve “hits” in the search results under the direction of the user 102.

To enable a quick return of search results, documents in a collection are pre-processed before a search query is entered. Potential search terms in each document in the collection are analyzed, and an indexing weight is assigned to each potential search term in each document. According to aspects of the present invention, the indexing weights are based on both traditional text-based considerations of the documents and on considerations particular to spoken queries (that is, on acoustic considerations). Normally, this pre-search work of assigning indexing weights is performed on the remote search server 106.

When a spoken search query is entered by the user 102 into his personal communication device 104, the search terms in the query are analyzed and compared to the indexing weights previously assigned to the search terms in the documents in the collection. Based on the indexing weights, appropriate documents are returned as hits to the user 102. To place the most appropriate documents high in the returned list of hits, the hits are ordered based, at least in part, on the indexing weights of the search terms.

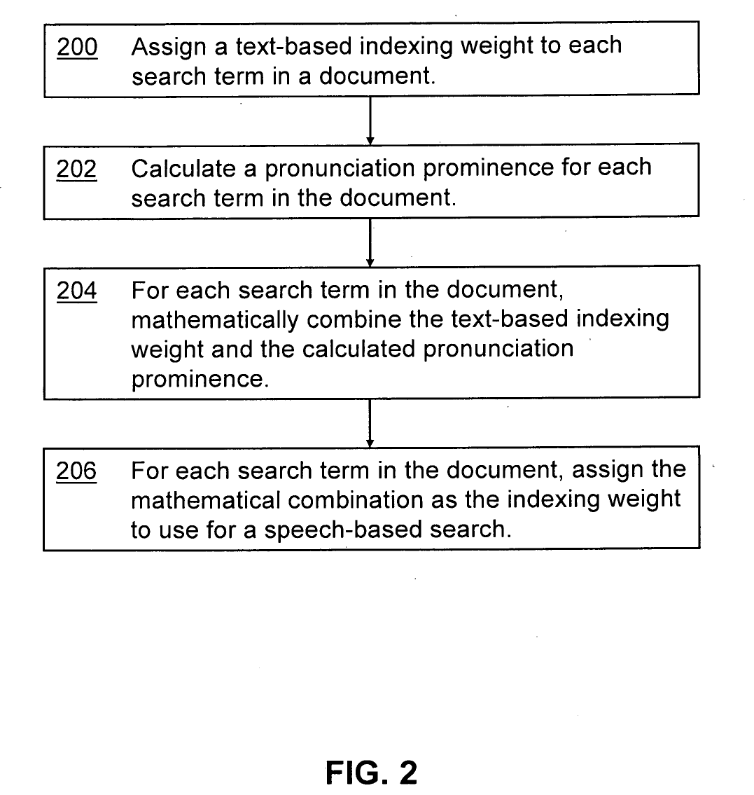

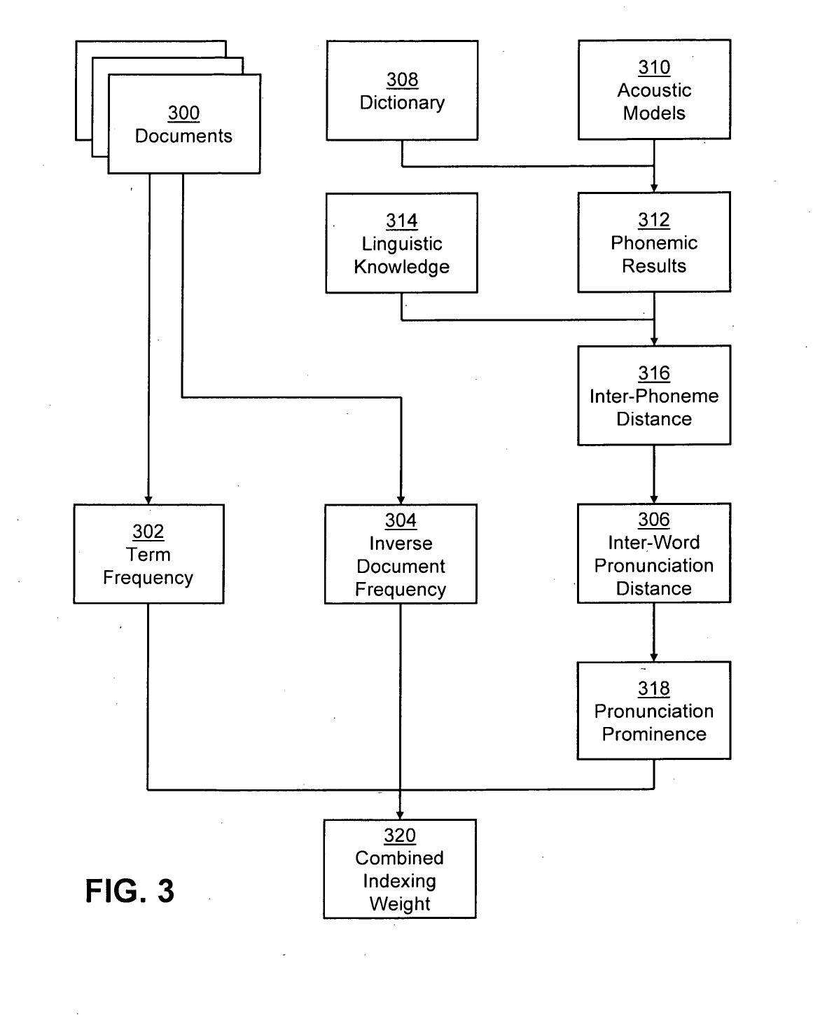

FIG. 2 presents an embodiment of the methods of the present invention. FIG. 3 shows how data flow through an embodiment of the present invention. These two figures are considered together in the following discussion.

Step 200 applies well known techniques to calculate a first component of the final compound indexing weight. Here, a text-based indexing weight is assigned to each potential search term in a document. While multiple text-based indexing weights are known and can be used, the following example describes the well known TF-IDF indexing weight. Applying known techniques, the documents (300 in FIG. 3) in the collection of documents are first pre-processed to remove garbage, to clean up punctuation, to reduce inflected (or sometimes derived) words to their stem, base, or root forms, and to filter out stopwords. Each document is then converted into a word vector. The word vectors are used for calculating TF (term frequency) for the document and IDF (inverse document frequency) for the collection of documents. Specifically, TF (302 in FIG. 3) is the normalized count of a term tₘ within a particular document d_{q}:

$${TF}_{mq} = \frac{{n}_{mq}}{{\sum }_{k} {n}_{kq}}$$

where n_{mq} is the number of occurrences of the term tₘ in the document d_{q}, and the denominator is the number of occurrences of all terms in the document d_{q}. The IDF (304 in FIG. 3) of a term tₘ in the collection of documents is:

$${IDF}_{m} = ln \frac{\vert D \vert}{\vert \{ {d}_{q} \text{:} {t}_{m} ∈ {d}_{q} \} \vert}$$

where |D| is the total number of documents in the collection, while the denominator represents the number of documents where the term tₘ appears. The TF-IDF weight is then:

TF−IDF_{mq}=TF_{mq}·IDFₘ

which measures how important a term tₘ is to the document d_{q} in the collection of documents. Different embodiments can use other text-based indexing weights, such as TF-DV, instead of TF-IDF.

In step 202 a second component of the final compound indexing weight is calculated. Here, a speech-based indexing weight (called the “pronunciation prominence”) is assigned to each potential search term in a document. To summarize, a dictionary (308 in FIG. 3) is first used to translate each word into its phonetic pronunciations. Second, an inter-word pronunciation distance (306) is calculated based on an inter-phoneme distance (316). Then, from the proceeding a pronunciation prominence (318) is calculated for the word.

Several known techniques can be used to estimate the inter-phoneme distance (“IPD”). These techniques usually fall into either a data-driven family of techniques or a phonetic-based family.

To use a data-driven approach to estimate the IPD, assume that a certain amount of speech data are available for a phonemic recognition test. Then a phonemic confusion matrix is derived from the result of recognition using an open-phoneme grammar. The phonemic inventory is denoted as {pᵢ|i=1, . . . , I}, where I is the total number of phonemes in the inventory. Denote each element in the confusion matrix by C(pⱼ|pᵢ) which represents the number of instances when a phoneme pᵢ is recognized as pⱼ. Then, the recognition is correct when pⱼ=pᵢ, and it is incorrect when pⱼ≠pᵢ. In some embodiments, pause and silence models are included in the phonemic inventory. In these embodiments, a confusion matrix also provides information about deletion (when pⱼ=pause or silence) and insertion (when pᵢ=pause or silence) of each phoneme. The tendency of a phoneme pᵢ being recognized as pⱼ is defined as:

$$d ( {p}_{j} \vert {p}_{i} ) = \frac{C ( {p}_{j} \vert {p}_{i} )}{{\sum }_{j = 1}^{I} C ( {p}_{j} \vert {p}_{i} )}$$

Note that this quantity characterizes closeness between the two phonemes pᵢ and pⱼ, but it is not a distance measure in a strict sense because it is not symmetric, i.e.:

d(pⱼ|pᵢ)≠d(pᵢ|pⱼ)

A phonetic-based technique estimates the IPD solely from phonetic knowledge. Characterization of a quantitative relationship between phonemes in a purely phonetic domain is well known. Generally the relationship represents each phoneme as a vector with each of its elements corresponding to a distinctive phonetic feature, i.e.:

f(pᵢ)=[vᵢ(l)]^{T}

for l=1, . . . , L, where the vector contains a total of L elements or features, each element taking the value of either one when the feature is present or zero when the feature is absent. Recognizing the difference of features in contribution to the phonemic distinction, the features are modified with a weight factor. The weight is derived from the relative frequency of each feature in the language. Let c(pᵢ) denote the occurrence count of a phoneme pᵢ, then the frequency of each feature l contributed by the phoneme pᵢ is c(pᵢ)vᵢ(l), and the frequency of each feature l contributed by all of the phonemes is Σᵢ₌₁^{I}c(pᵢ)vᵢ(l). The weights derived from all the phonemes in the language are:

W=diag{w(1), . . . , w(l), . . . , w(L)}

where the weight for each specific feature l is:

$$w ( l ) = \frac{{\sum }_{i = 1}^{I} c ( {p}_{i} ) {v}_{i} ( l )}{{\sum }_{{l}^{′} = 1}^{L} {\sum }_{i = 1}^{I} c ( {p}_{i} ) {v}_{i} ( {l}^{′} )} l = 1 , … , L$$

and where diag(vector) is a diagonal matrix with elements of the vector as the diagonal entries. The estimated phonemic distance between two phonemes pᵢ and pⱼ is calculated as:

$$\begin{matrix}d ( {p}_{j} \vert {p}_{i} ) = {‖ W [ f ( {p}_{i} ) - f ( {p}_{j} ) ] ‖}_{1} \\ = {\sum }_{l = 1}^{L} w ( l ) \vert {v}_{i} ( l ) - {v}_{j} ( l ) \vert\end{matrix}$$

where i=1, . . . , I, and j=1, . . . , I. The distance between a phoneme and silence or pause is artificially made to be:

$$d ( sil \vert {p}_{i} ) = d ( {p}_{i} \vert sil ) = {avg}_{j} d ( {p}_{j} \vert {p}_{i} )$$

Regardless of how the IPDs (316 in FIG. 3) are calculated, the next step is to calculate the inter-word pronunciation confusability or inter-word pronunciation distance (306). In estimating the possibility of a term tₘ to be confused in pronunciation by another term tₙ, embodiments of the present invention can use a modified version of the well known Levenshtein distance. The Levenshtein distance measures edit distance between two text strings. Originally, the distance is given by the minimum number of operations needed to transform one text string into the other, where an operation is an insertion, deletion, or substitution of a single character. In the modified version of the present invention, the Levenshtein distance is measured between the pronunciations, i.e., between the strings of phonemes, of any two words tₘ and tₙ. The insertion, deletion, or substitution of a phoneme pᵢ is associated with a punishing cost Q. The modified Levenshtein distance between two pronunciation strings Pₜ_{ₘ} and Pₜ_{ₙ} is:

D(tₙ|tₘ)=LD(Pₜ_{ₘ},Pₜ_{ₙ};Q(pⱼ|pᵢ):pᵢ∈Pₜ_{ₘ},pⱼ∈Pₜ_{ₙ})

where LD stands for Levenshtein distance and can be realized with a bottom-up dynamic programming algorithm. This distance is a function of the pronunciation strings of the two words to be compared as well as of a cost Q. The cost can be represented by the IPD discussed above. That is:

Q(pⱼ|pᵢ)=d(pⱼ|pᵢ)

This is not a probability, and D(tₙ|tₘ) is therefore referred to as a tendency or possibility of the word tₘ to be recognized as the word tₙ. When tₙ=tₘ the recognition is correct, and when tₙ≠tₘ the recognition is incorrect.

Based on the above, the pronunciation prominence (318) (or robustness) of the word tₘ is characterized as:

$${R}_{m} = {avg}_{{t}_{n} ∈ S ( {t}_{m} )} D ( {t}_{n} \vert {t}_{m} ) - D ( {t}_{m} \vert {t}_{m} )$$

In the above metric, the first term measures the average tendency of the word wₘ to be confused by a group of acoustically closest words, S(tₘ), thus:

D(tₙ|tₘ)≦D(t_{n′}|tₘ),

∀tₙ∈S(tₘ),

∀t_{n′}∉S(tₘ)

In our tests, we control S(tₘ) to include top five most confusing words for each tₘ. There are situations when the acoustic model set is poor in recognizing some words tₘ so that Rₘ<0. In this case, set Rₘ=0. The pronunciation prominence can be enhanced through a transformation:

PPₘ=F(Rₘ)

where the enhancement function F( ) can take many forms. In testing, we use the power function:

PPₘ=(Rₘ)^{r}

The power parameter r is a natural number greater than zero and is used to enhance the pronunciation prominence relative to the existing TF-IDF. In our tests, 1≦r≦5 generally suffices.

In step 204 of FIG. 2, the text-based indexing weight (from step 200) and the pronunciation prominence (from step 202) are mathematically combined to create the new indexing weight. For example, when the text-based indexing weight is TF-IDF, the final weight is a TF-IDF-PP weight (320 in FIG. 3):

(TF-IDF-PP)_{mq}=TF_{mq}·IDFₘ·PPₘ

This new weight will then be used for speech-based searching (step 206).

A test has been run on 500 pieces of email randomly selected from the Enron Email database. The email headers, non-alphabetical characters, and punctuation are filtered out. The emails are further screened through a stopword list containing 818 words. After cleaning and filtering, the 500 emails contain a total of 52,488 words with 8,358 unique words.

For speech recognition, a context-independent acoustic model set is used containing three-state HMMs. The features are regular 13 cepstral coefficients, 13 first-order cepstral derivative coefficients, and 13 second-order cepstral derivative coefficients. In the speech recognition of keywords, a bigram language model is used. In the speech recognition result, a word accuracy A(tₘ) is obtained for each word tₘ. Therefore, the probability to conduct a successful location of a document d_{q} can be estimated by:

$$A ( {d}_{q} ) = {\prod }_{m} A ( {t}_{m} )$$

Note the multiplication is conducted on a top subset of the word list associated with the indexing weight. Then an average accuracy across all the documents in the collection can be obtained as:

$$A = {\sum }_{q} A ( {d}_{q} )$$

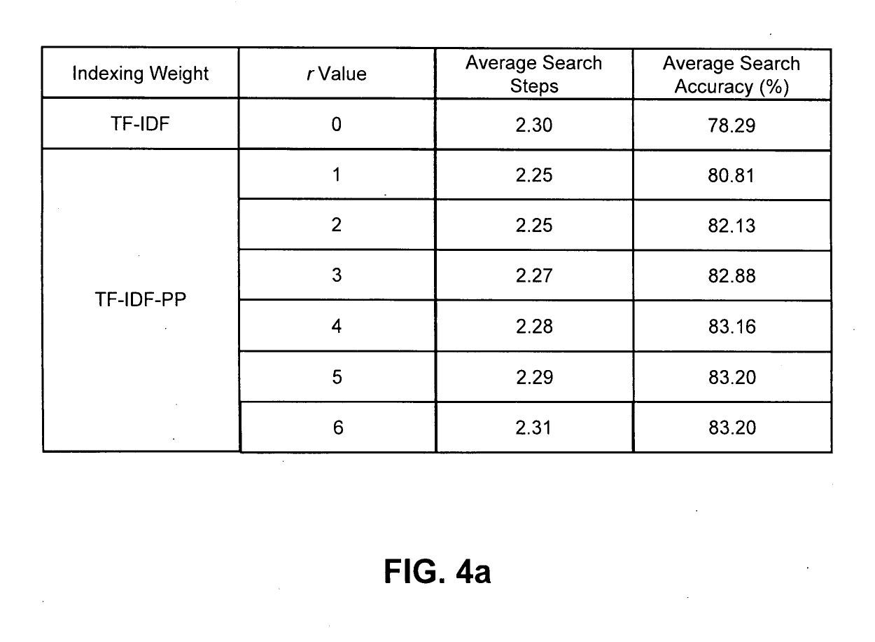

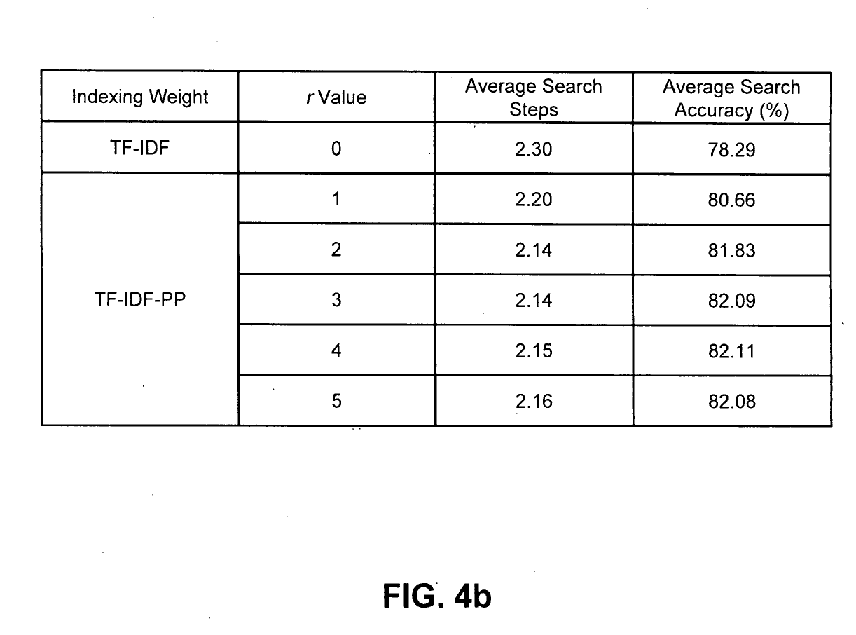

The Table of FIG. 4a shows the search performance comparing TF-IDF and TF-IDF-PP where PP is derived with a data-driven IPD. The FIG. 4a Table shows that both the average number of search steps and the average search accuracy improved with TF-IDF-PP relative to TF-IDF. It is understandable that TF-IDF may not necessarily provide the minimal search steps in the current search tests, since the IDF for each term is obtained globally, while in the search tests the searches after the first step are local. We also made some approximate estimations on how much benefit is obtained in the search accuracy due to the reduction of search steps. By using the average performance of our speech recognizer as 90% word accuracy, the change in the average number of steps from 2.30 to 2.25 would have only resulted in a change from 78.29% to 78.47% in the average search accuracy. Therefore, we can say the improvement in the average search accuracy is largely due to use of acoustically more robust terms as keywords. The results in the FIG. 4a Table show that a significant improvement is obtained by using TF-IDF-PP instead of TF-IDF as the indexing weight when the pronunciation prominence factor PP is derived from the phonemic confusion matrix of the speech recognizer. The benefit increases with the parameter r, i.e., an enhancement of prominence, while it saturates when r is big, e.g., r>5. By using the new indexing weight, we obtained an average five percentage point increase in search accuracy.

The results of another test are shown in the Table of FIG. 4b. Here, a pronunciation prominence factor is derived from phonetic knowledge (314 in FIG. 3). The test shows similar improvement in search accuracy. The improvement is slightly smaller than the results shown in the FIG. 4a Table.

Compared with the existing TF-IDF weights that focus solely on text information, the methods of the present invention provide an index that takes into account information in both the text domain and in the acoustic domain. This strategy results in a better choice for a speech-based search. As shown in the experimental results of FIGS. 4a and 4b, the search efficiency with the new measure is five percentage points higher than with the standard TF-IDF measure.

In view of the many possible embodiments to which the principles of the present invention may be applied, it should be recognized that the embodiments described herein with respect to the drawing figures are meant to be illustrative only and should not be taken as limiting the scope of the invention. For example, other text-based and speech-based measures can be used to calculate the final indexing weights. Therefore, the invention as described herein contemplates all such embodiments as may come within the scope of the following claims and equivalents thereof.

We claim:

1. A method for assigning an indexing weight to a search term in a document, the document in a collection of documents, the method comprising:
calculating a text-based indexing weight for the search term in the document;
calculating a pronunciation prominence for the search term; and
assigning an indexing weight to the search term in the document, the indexing weight based, at least in part, on a mathematical combination of the calculated text-based indexing weight and the calculated pronunciation prominence.

2. The method of claim 1 wherein calculating a text-based indexing weight for the search term in the document comprises:
calculating a term frequency for the search term in the document;
calculating an inverse document frequency for the search term in the collection of documents; and
calculating the text-based indexing weight for the search term in the document by mathematically combining the calculated term frequency and the calculated inverse document frequency.

3. The method of claim 1 wherein calculating a text-based indexing weight for the search term in the document comprises:
calculating a term frequency for the search term in the document;
calculating a discrimination value for the search term in the collection of documents; and
calculating the text-based indexing weight for the search term in the document by mathematically combining the calculated term frequency and the calculated discrimination value.

4. The method of claim 1 wherein calculating a pronunciation prominence for the search term comprises:
translating terms in the documents in the collection of documents into phonetic pronunciations;
calculating inter-term pronunciation distances between pairs of the translated terms, the calculating based, at least in part, on inter-phoneme distances; and
calculating the search term pronunciation prominence, the calculating based, at least in part, on inter-term pronunciation distances.

5. The method of claim 4 further comprising:
calculating an inter-phoneme distance, the calculating based, at least in part, on a technique selected from the group consisting of: a data-driven technique and a phonetic-based technique.

6. The method of claim 5 wherein the data-driven technique comprises:
deriving a phonemic confusion matrix, the deriving based, at least in part, on a phonemic recognition with an open phoneme grammar.

7. The method of claim 5 wherein the phonetic-based technique comprises:
representing each of a first and a second phoneme as a vector with each vector element corresponding to a distinctive phonetic feature of the respective phoneme;
weighting the vector elements, the weighting based, at least in part, on a relative frequency of each feature in a language, the language comprising the first and second phonemes; and
estimating the inter-phoneme distance between the first and second phonemes, the estimating based, at least in part, on the vectors of the first and second phonemes.

8. The method of claim 4 wherein calculating the inter-term pronunciation distance between a pair of translated terms comprises calculating an inter-term pronunciation confusability between the pair of translated terms.

9. The method of claim 8 wherein the inter-term pronunciation confusability is a modified Levenshtein distance between pronunciations of the pair of translated terms.

10. The method of claim 4 wherein calculating the search term pronunciation prominence comprises taking an average over a group of terms acoustically closest to the search term of an inter-term pronunciation distance between the search term and another term.

11. The method of claim 1 wherein the indexing weight assigned to the search term in the document is a multiplicative product of the calculated text-based indexing weight and the calculated pronunciation prominence.

12. A voice-to-text-search indexing server comprising:
a memory configured for storing an indexing weight assigned to a search term in a document, the document in a collection of documents; and
a processor operatively coupled to the memory and configured for calculating a text-based indexing weight for the search term in the document, for calculating a pronunciation prominence for the search term, and for assigning an indexing weight to the search term in the document, the indexing weight based, at least in part, on a mathematical combination of the calculated text-based indexing weight and the calculated pronunciation prominence.

13. The voice-to-text-search indexing server of claim 12 wherein calculating a text-based indexing weight for the search term in the document comprises:
calculating a term frequency for the search term in the document;
calculating an inverse document frequency for the search term in the collection of documents; and
calculating the text-based indexing weight for the search term in the document by mathematically combining the calculated term frequency and the calculated inverse document frequency.

14. The voice-to-text-search indexing server of claim 12 wherein calculating a text-based indexing weight for the search term in the document comprises:
calculating a term frequency for the search term in the document;
calculating a discrimination value for the search term in the collection of documents; and
calculating the text-based indexing weight for the search term in the document by mathematically combining the calculated term frequency and the calculated discrimination value.

15. The voice-to-text-search indexing server of claim 12 wherein calculating a pronunciation prominence for the search term comprises:
translating terms in the documents in the collection of documents into phonetic pronunciations;
calculating inter-term pronunciation distances between pairs of the translated terms, the calculating based, at least in part, on inter-phoneme distances; and
calculating the search term pronunciation prominence, the calculating based, at least in part, on inter-term pronunciation distances.

16. The voice-to-text-search indexing server of claim 15 further comprising:
calculating an inter-phoneme distance, the calculating based, at least in part, on a technique selected from the group consisting of: a data-driven technique and a phonetic-based technique.

17. The voice-to-text-search indexing server of claim 16 wherein the data-driven technique comprises:
deriving a phonemic confusion matrix, the deriving based, at least in part, on a phonemic recognition with an open phoneme grammar.

18. The voice-to-text-search indexing server of claim 16 wherein the phonetic-based technique comprises:
representing each of a first and a second phoneme as a vector with each vector element corresponding to a distinctive phonetic feature of the respective phoneme;
weighting the vector elements, the weighting based, at least in part, on a relative frequency of each feature in a language, the language comprising the first and second phonemes; and
estimating the inter-phoneme distance between the first and second phonemes, the estimating based, at least in part, on the vectors of the first and second phonemes.

19. The voice-to-text-search indexing server of claim 15 wherein calculating the inter-term pronunciation distance between a pair of translated terms comprises calculating an inter-term pronunciation confusability between the pair of translated terms.

20. The voice-to-text-search indexing server of claim 19 wherein the inter-term pronunciation confusability is a modified Levenshtein distance between pronunciations of the pair of translated terms.

21. The voice-to-text-search indexing server of claim 15 wherein calculating the search term pronunciation prominence comprises taking an average over a group of terms acoustically closest to the search term of an inter-term pronunciation distance between the search term and another term.

22. The voice-to-text-search indexing server of claim 12 wherein the indexing weight assigned to the search term in the document is a multiplicative product of the calculated text-based indexing weight and the calculated pronunciation prominence.
